(19) United States
(12) Patent Application Publication
(10) Pub. No.: US 2016/0003702 A1
(43) Pub. Date: Jan. 7, 2016

(54) A PIPELINE LEAK DETECTION SYSTEM

(71) Applicant: GAS PIPELINE PROTECTION PTY LTD, Chinchilla QLD (AU)

(72) Inventor: Gary LYNCH, Queensland (AU)

(73) Assignee: GAS PIPELINE PROTECTION PTY LTD, Queensland (AU)

(21) Appl. No.: 14/770,360

(22) PCT Filed: Mar. 31, 2014
(86) PCT No.: PCT/AU2014/000336

§ 371 Date: Aug. 25, 2015

(30) Foreign Application Priority Data
Feb. 26, 2013 (AU) 2013900675

(51) Int. Cl. G01M 3/02

(52) U.S. Cl. CPC G01M 3/02

(57) ABSTRACT

The invention generally relates to a pipeline leak detection system. The system, comprising at least one fluid collection member adapted to be placed adjacent a pipeline and adapted to receive fluid leaking from the pipeline; a flexible cover covering at feast part of the pipeline and the at least one fluid collection member; and a fluid detector in fluid communication with the at least one fluid collection member.

### FIELD OF THE INVENTION

The invention relates to a pipeline leak detection system. In particular, although not exclusively, the present invention relates to a leak detection system for a gas pipeline.

### BACKGROUND TO THE INVENTION

Pipelines are widely used to transport various fluids from one location to another. The fluids are typically transported under high pressure and at high flow rates.

Leaks in pipelines can be expensive and dangerous. Pipeline corrosion can result in the release of the pipeline's contents into the surrounding environment. Other factors including soil subsidence, local construction projects, seismic activity, weather, and degradation caused by normal use can also lead to defects and anomalies in a pipeline. Natural gas leaks from larger pipelines can be extremely dangerous, with ‘kill zones’ of up to 900 m if the gas is ignited.

The internal and external surface walls of a pipeline are susceptible to damage by various factors. These factors may include: reactivity to the material flowing through the pipeline; pressure, temperature and chemical characteristics of various products and contaminants inside and outside the pipeline;

mechanical damage; fatigue; cracks; stress; distortion due to dents or wrinkles.

The identification of early stage leaks is crucial to pipeline maintenance. Locating such leaks in a buried pipeline is problematic. Currently such leaks are detected using pressure differences in the pipeline, using ultrasonic transducers to ‘listen’ for leaks and using ground and aerial surveillance in combination with laser detection of leaks.

Other systems of detecting leaks in smaller gas pipelines have also been proposed, for example US2003/0037596 discloses a pipeline having an inner pipe, a coaxial outer pipe and a sniffer pipe situated between the outer pipe and the inner pipe. However, such a solution increases the cost and the difficulty of manufacturing and installing a pipeline.

It will be clearly understood that any reference herein to background material or information, or to a prior publication, does not constitute an admission that any material, information or publication forms part of the common general knowledge in the art, or is otherwise admissible prior art, whether in Australia or in any other country.

Clearly it would be advantageous if a pipeline leak detection system could be devised that overcome or at least alleviated one or more of the above problems and/or provide the consumer with a useful or commercial choice.

### SUMMARY OF THE INVENTION

In one form, although it need not be the only or indeed the broadest form, the invention resides in an oil or gas pipeline leak detection system comprising:

at least one porous conduit fluid collection member adapted to be placed externally of and adjacent to a pipeline and adapted to receive fluid leaking from the pipeline;

a flexible cover covering at least part of the pipeline and the at least one porous conduit fluid collection member; and

a fluid detector in fluid communication with the at least one porous conduit fluid collection member.

Preferably, the at least one porous conduit fluid collection member may be a perforated pipe having holes sized to allow the transmission of the fluid into the pipe. In a preferred embodiment, each porous conduit is a porous hose. Preferably the porous hose is made of extruded porous rubber and/or plastic material. An example of a porous hose is the 3331HM dripping hose made by Holeman Industries.

If the at least one porous conduit is a plurality of porous conduits, this may include a combination of one or more perforated pipes and one or more porous hoses. Each porous conduit is typically attached to the pipeline using adhesives and/or the like.

In an alternate embodiment, the at least one porous conduit fluid collection member may further comprise at least one sump. A benefit of having a sump is that liquid leaking from a pipeline can be detected. For example, oil leaks may be detected.

In another embodiment, the at least one fluid collection member may be a plurality of porous conduit fluid collection members and/or one or more sumps. This can be beneficial as adding gas to a liquid flow may help find smaller leaks.

Preferably, if the at least one fluid collection member is a plurality of porous conduits, at least one porous conduit is located towards the top of the pipeline. Preferably, if the at least one fluid collection member is a plurality of porous conduits, at least one porous conduit is located towards the bottom of the pipeline. More preferably one porous conduit is located towards the top of the pipeline (e.g. on top of the pipeline) and two porous conduits are located towards the bottom of the pipeline.

Preferably the flexible cover comprises an impervious material. Preferably the flexible cover comprises a polyfabric. More preferably, the flexible cover comprises a polyethylene based polyfabric. For example, Canvacon 5000 (trade mark), a polyethylene based polyfabric sold by Gale Pacific Limited. A skilled addressee will understand that any suitable flexible cover may be used such as plastic sheet/foil material, PVC sheeting/foil, impervious fabrics and/or the like.

The flexible cover is typically coloured to provide a visual indication when the pipeline is being excavated (e.g. to act as a warning).

Preferably the flexible cover comprises a porous lining. Typically the porous lining will be positioned adjacent the pipeline and the at least one fluid collection member such that any fluid leaking from the pipeline can flow through the porous lining to the at least one fluid collection member. The porous lining may comprise a spun fabric such as a spun geo-fabric.

Preferably the flexible cover is wide enough to enclose the pipeline such that any backfill puts pressure on the flexible cover to keep it in place relative to the pipeline. Typically the flexible cover is placed around the pipeline and overlaps (e.g. one side of the flexible cover overlaps an opposed side). Normally the flexible cover overlaps underneath the pipeline. A benefit of this is that the overlap assists in sealing the flexible cover in at least one direction. Typically any backfill will assist in sealing the overlap of the flexible cover. Preferably the flexible cover is attached to itself where it overlaps.

Preferably, ends of the flexible cover are attached to the pipeline. Alternatively the flexible cover can be intermittently attached to the pipeline. Typically the attached ends or intermittently attached portions of the flexible cover define a section of pipeline therebetween. A benefit of defining a section of pipeline in this manner is that if fluid is detected in any fluid collection member associated with the defined section of pipeline, this would indicate that the leak is situated in the defined section of the pipeline. In critical areas, subject to earth movement for example, sections may be shorter in length. For example, sections may be 50 meters or less in length such that the position of any leaks that are detected can be quickly located, compared to longer sections.

Typically the flexible cover is attached to the pipeline using bands to strap the flexible cover to the pipeline. For example, using plastic and/or stainless steel bands which are tightened around the flexible cover and pipeline and have end portions crimped together. If a band is used to attach the flexible cover to the pipeline and define a section of pipeline, the band may be tightened such that any porous conduit fluid collection member is ‘clamped’ under the band such that any fluid collected by the porous conduit fluid collection member in one section does not flow into another section.

A benefit of using a flexible cover is that the pipeline leak detection system can be easily retrofitted to existing pipelines or installed at the same time as a pipeline is being installed.

Preferably, if the pipeline is transporting gas, the fluid detector is a gas detector. Alternatively, if the pipeline is transporting a liquid, the fluid detector may be a liquid detector. Fluid detectors such as gas and liquid detectors are well known in the art and will not be described in any further detail in this specification.

Typically, a vacuum pump will be in fluid communication with the fluid detector to bring leaked fluid towards the fluid detector such that the fluid can be detected.

Preferably, a transmitter is in operational communication with the fluid detector. In this manner, if a leaked fluid is detected, a signal may be transmitted to a monitoring station. Typically such a signal would include at least one of the following: the location or designation of the fluid detector, the location or designation of the porous conduit fluid collection member from which the fluid was detected and the amount of fluid detected.

In an alternative embodiment, the fluid detector may be a portable fluid detector.

Preferably the pipeline leak detection system further comprises a vent pipe in fluid communication with the at least one porous conduit fluid collection member. Typically the vent pipe extends sufficiently above the pipeline and ground level to help vent gas leaks. A benefit of this is that the vent pipe helps to disperse leaked gas and prevents pooling of gas at ground level. An additional benefit of providing a vent pipe is that a handheld gas detector such as a handheld laser gas detector can be used to remotely determine if gas is venting from the vent pipe.

Preferably the pipeline leak detection system further comprises an isolation valve disposed between each of the at least one porous conduit fluid collection member and the fluid detector. In this manner, if there is a plurality of porous conduit fluid collection members, it may be determined which of the porous conduit fluid collection members is receiving fluid leaking from the pipeline (e.g. by isolating the porous conduit fluid collection members and checking each in turn). A benefit of this is that it can help determine which part of the pipeline has the leak. Preferably the isolation valves are actuated by solenoids. Preferably the isolation valves are automatically actuated when a leak is detected to determine which of the porous conduit fluid collection members is receiving fluid. Typically a non-return valve is disposed between each of the at least one porous conduit fluid collection member and the fluid detector such that fluid from one porous conduit fluid collection member cannot flow into another porous conduit fluid collection member.

Typically the pipeline is a buried pipeline. The pipeline leak detection system may be retrofitted to an existing buried pipeline. Alternatively, the pipeline leak detection system may be installed at the same time as the pipeline is being installed. If the pipeline leak detection system is to be retrofitted to an existing buried pipeline, the existing buried pipeline is typically excavated using suction excavation (e.g. the earth/material around the pipeline is removed using suction).

In another form the invention relates to a method of installing a pipeline leak detection system, comprising the steps of:

providing at least one porous conduit fluid collection member externally of and adjacent to an oil or gas pipeline such that the at least one porous conduit fluid collection member can receive fluid leaking from the pipeline;

fluidly connecting the at least one porous conduit fluid collection member to a fluid detector; and

covering at least part of the pipeline and the at least one porous conduit fluid collection member with a flexible cover.

Preferably the step of providing at least one porous conduit fluid collection member externally of and adjacent a pipeline includes attaching the at least one porous conduit fluid collection member to the pipeline. Preferably each of the at least one porous conduit fluid collection member is attached to the pipeline using adhesive.

Preferably the method further comprises the step of providing isolation valves between the at least one porous conduit fluid collection member and the fluid detector.

Preferably the step of covering at least part of the pipeline and the at least one porous conduit fluid collection member with a flexible cover includes attaching ends of the flexible cover to the pipeline.

Preferably the method includes the step of providing the pipeline. Alternatively, the method may include the step of excavating the pipeline (e.g. removing earth and/or the like from around the pipeline). If the pipeline is to be excavated, this is preferably done by suction excavation to avoid damage to the pipeline.

Preferably the method further comprises the step of backfilling around the pipeline such that earth/material presses the flexible cover against the pipeline and the at least one porous conduit fluid collection member.

In a further form, the invention resides in a pipeline leak detection system comprising:

an oil or gas pipeline for transmitting fluid;

at least one porous conduit fluid collection member located externally of and adjacent to the pipeline and adapted to receive fluid leaking from the pipeline;

a flexible cover covering at least part of the pipeline and the at least one porous conduit fluid collection member; and

a fluid detector in fluid communication with the at least one porous conduit fluid collection member.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, wherein:

FIG. 1 shows a cross section of a pipeline according to an embodiment of the invention;

FIG. 2 shows a cross section of a pipeline according to an embodiment of the invention;

FIG. 3 shows a cross section of a pipeline according to an embodiment of the invention;

FIG. 4 shows a cross section of a pipeline according to an embodiment of the invention;

FIG. 5 shows a side view of a pipeline according to an embodiment of the invention;

FIG. 6a shows a side view of a pipeline according to an embodiment of the invention;

FIG. 6b shows a side view of a pipeline according to an embodiment of the invention;

FIG. 7 shows a section view of a flexible cover according to an embodiment of the invention;

FIG. 8 shows a vent pipe assembly according to an embodiment of the invention;

FIG. 9 shows a side view of a pipeline according to an embodiment of the invention; and

FIG. 10 shows a cross section of a pipeline according to an embodiment of the invention.

### DETAILED DESCRIPTION OF THE INVENTION

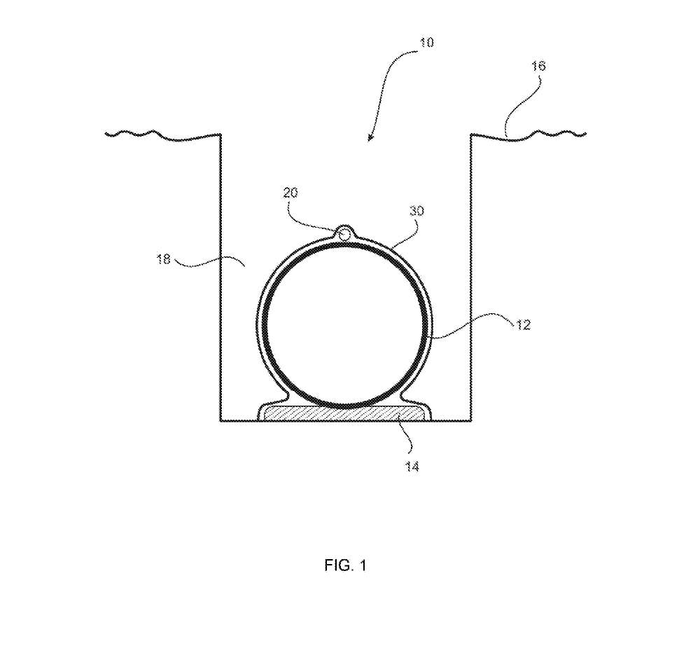

With reference to FIG. 1, there is shown part of a pipeline leak detection system 10. A pipeline 12 is supported by a pipeline support 14 below ground level 16 in a trench 18. A fluid collection member in the form of a porous hose 20 is attached to the top of the pipeline 12. A flexible cover 30 covers the pipeline 12 and the porous hose 20.

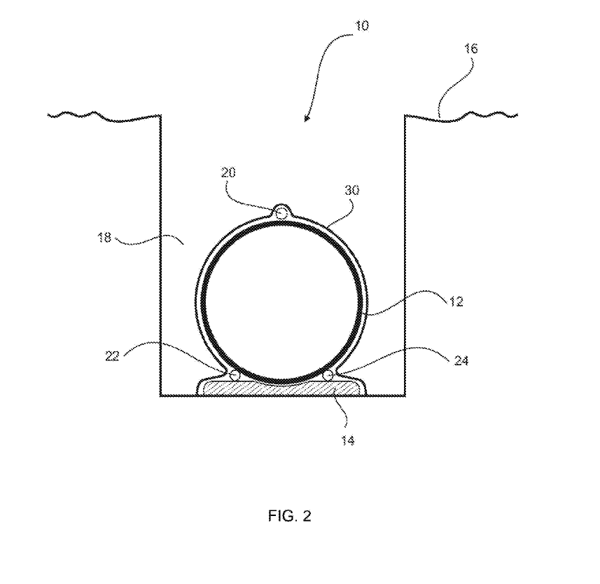

FIG. 2 shows part of a pipeline leak detection system 10 where porous hose 20 is attached to the top of the pipeline 12 and porous hoses 22, 24 are attached towards the bottom of the pipeline 12. The pipeline 12 and the porous hoses 20, 22, 24 are covered by the flexible cover 30. An advantage of having porous hoses 22 and 24 located towards the bottom of pipeline 12 is that heavier gases that tend to sink can be received by porous hoses 22 and 24. Similarly, porous hose 20 can receive lighter gases that have a tendency to float upwards.

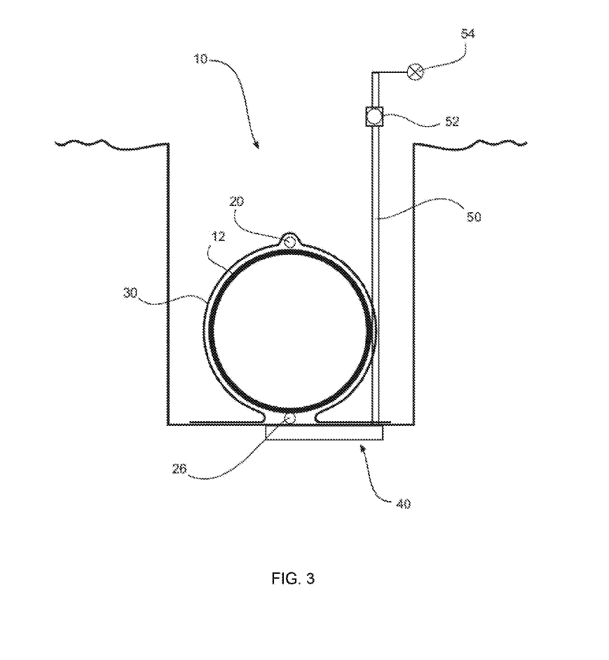

FIG. 3 shows part of a pipeline leak detection system 10 where porous hose 20 is attached to the top of the pipeline 12 and porous hose 26 is attached to the bottom of the pipeline 12. A fluid collection member in the form of a sump 40 is placed under the pipeline 12 to collect liquid (not shown) which may leak from the pipeline 12. The pipeline 12, porous hoses 20, 26 and the sump 40 are covered by the flexible cover 30.

The sump 40 is fluidly connected by pipe 50 to a fluid detector in the form of a liquid detector 52. A vacuum pump 54 is fluidly connected to the liquid detector 52 such that any liquid (not shown) in the sump 40 can be drawn into the liquid detector 52.

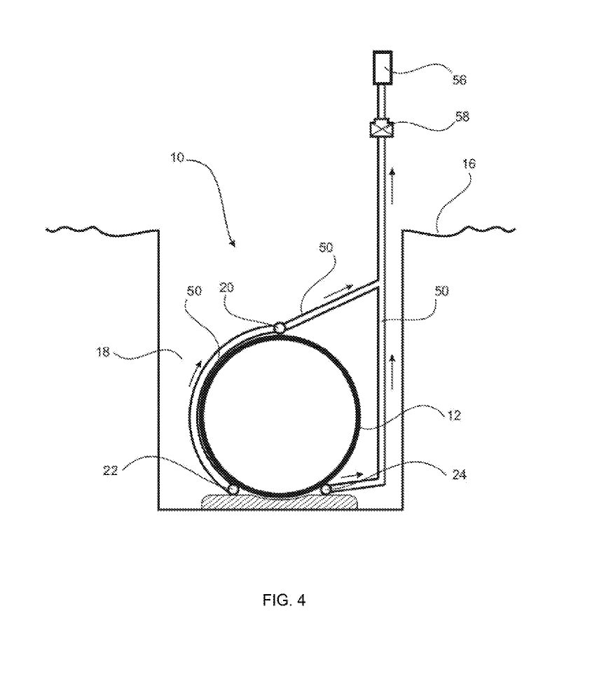

FIG. 4 shows part of a pipeline leak detection system 10 where porous hoses 20, 22, 24 are fluidly connected by pipes 50 to a fluid detector in the form of a gas detector 56 (the flexible cover has been omitted for clarity). An isolation valve 58 is disposed between the porous hoses 20, 22, 24 and the gas detector 56. A vacuum pump (not shown) is typically fluidly connected to the gas detector 56 to draw any gas from the porous hoses 20, 22, 24 via pipes 50 into the gas detector 56.

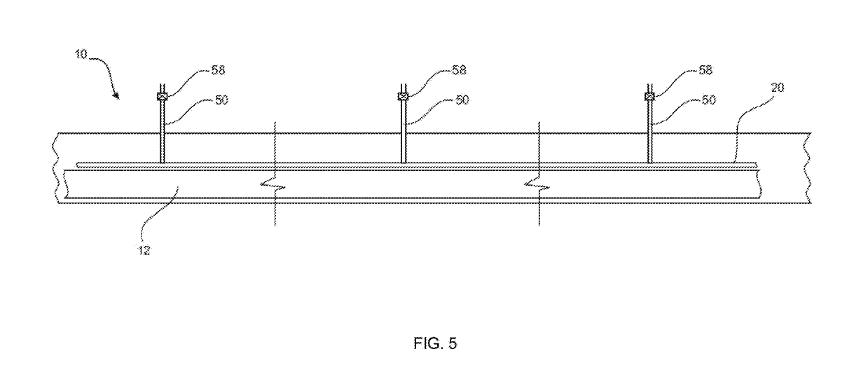

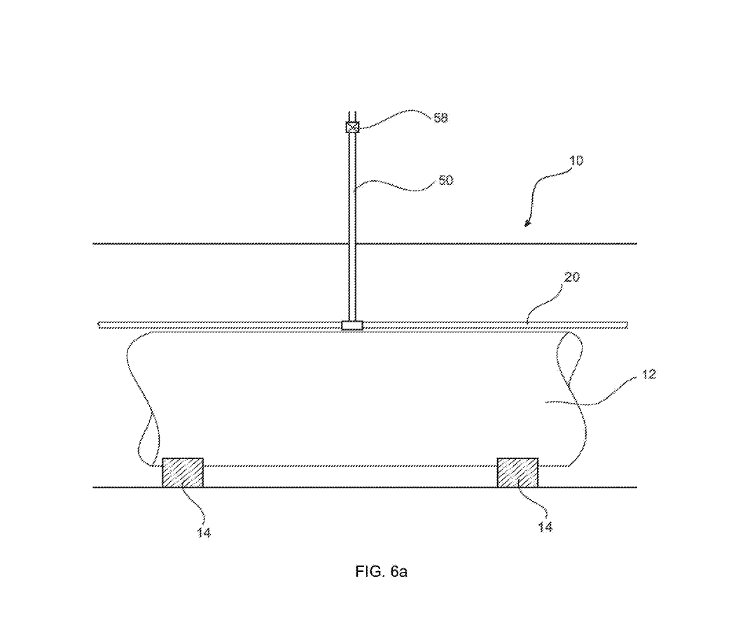

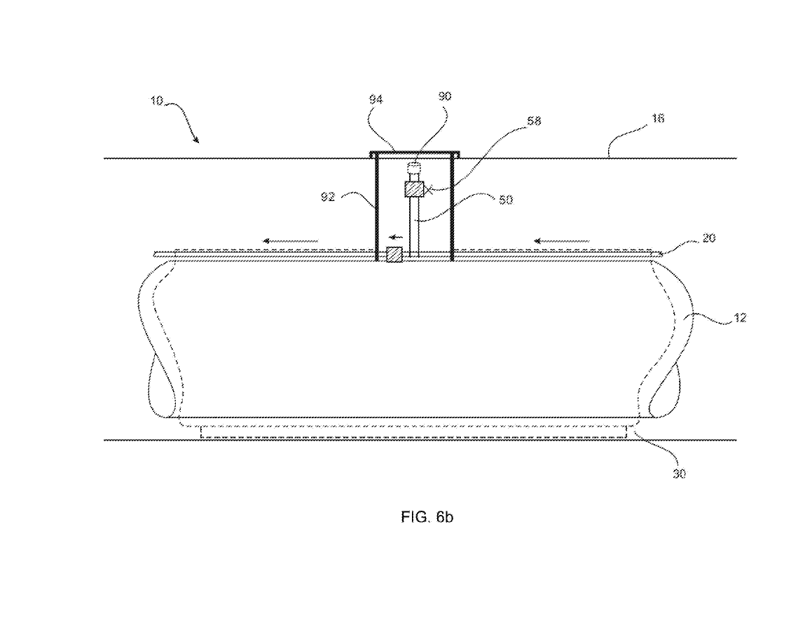

FIGS. 5 and 6a show a side view of a pipeline leak detection system 10 where porous hose 20 is connected to pipes 50 extending above the pipeline 12. Pipes 50 extend above the pipeline 12 at predetermined intervals (as can best be seen in FIG. 5). An isolation valve 58 is fluidly connected to each pipe 50. Typically, a gas detector (not shown) is fluidly connected to each isolation valve 58. Alternatively, a mobile gas detector (not shown) can be releasably and fluidly connected to each isolation valve 58 as needed.

FIG. 6b shows a side view of a pipeline leak detection system 10 similar to the pipeline leak detection systems in FIGS. 5 and 6a. In this embodiment, a porous hose 20 is connected to pipe 50 extending above the pipeline 12. An isolation valve 58 is situated towards the top of pipe 50 and a connector 90 is situated above the isolation valve 58. In this manner, a mobile gas detector (not shown) can be releasably and fluidly connected to the pipe 50, alternatively or additionally, a vent pipe (not shown) can be releasably and fluidly connected to the pipe 50. The pipe 50, isolation valve 58 and connector 90 are contained in a valve box 92 below (or close to) ground level 16. A lid 94 covers the valve box 92 for easy access. The valve box 92 may be manufactured from any suitable material which can safely retain the pipe 50, the isolation valve 58 and the connector 90. For example, a high density polyethylene (HDPE) or any polyethylene thermoplastic made from petroleum. HDPE is known for its large strength to density ratio and is commonly used in the production sumps and other plastic box products.

FIG. 6b also shows that the flexible cover 30 wraps around the pipeline 12 and overlaps itself underneath the pipeline 12. In this manner, when the pipeline 12 is backfilled, the backfill (not shown) will put pressure on the flexible cover 30, assisting in the sealing of the flexible cover 30.

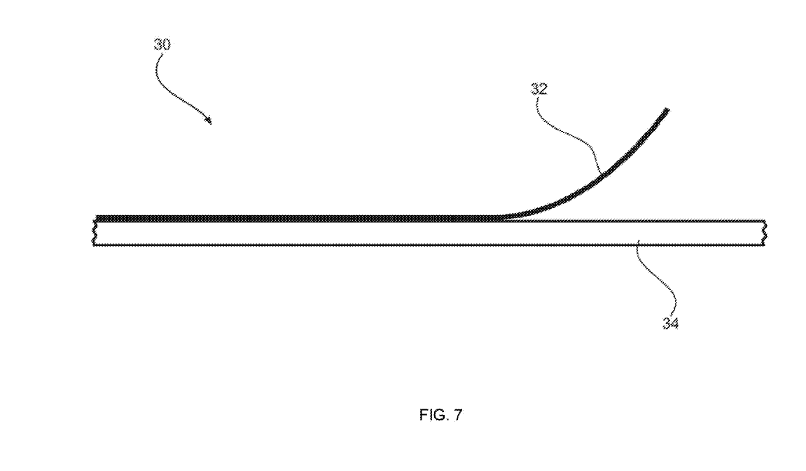

FIG. 7 shows a close up section view of the flexible cover 30. The flexible cover 30 has an outer layer 32 made of PVC sheet material and a liner in the form of an inner layer 34 made of a porous geo fabric material. A benefit of having an inner layer made of porous material is that any fluid leaking from a pipeline is able to pass through the inner layer to a fluid collection member.

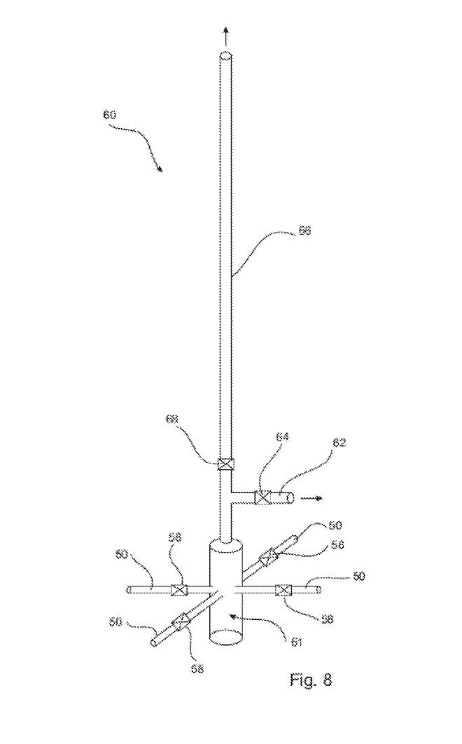

FIG. 8 shows a vent pipe assembly 60. Pipes 50 fluidly connect porous hoses (not shown) to a gas chamber 61. Isolation valves 58 are disposed between the pipes 50 and the gas chamber 61. Pipe 62 is fluidly connected to the gas chamber 61 and to a gas detector (not shown). An isolation valve 64 is disposed between pipe 62 and the gas chamber 61. In this manner, gas can be drawn from each of the pipes 50 to the gas detector (not shown) in turn, to determine which of the porous hoses (not shown) is receiving leaked gas. A vent pipe 66 is fluidly connected to the gas chamber 61 to vent gas from the gas chamber 61. In this embodiment of the invention, the gas chamber 61 has a single upright venting pipe 66 attached, with isolating valves 68 incorporated to control venting and to allow the attachment of a portable gas detector and vacuum pump. The top of the vent pipe 66 is allowed to be open, with all of the monitoring gas pipes also open to the gas chamber 61, so as to allow any gas leaks to vent. The height of this venting pipe 66 is sufficient to help with the dispersion of leaked gas and to prevent pooling of gas at ground level around the gas chamber 61.

An isolation valve 68 is disposed between the gas chamber 61 and the vent pipe 66 to regulate the venting of gas from the gas chamber 61. The gas chamber 61 may be manufactured from any suitable material which can safely retain the gas leaked from the pipeline 12. For example, a high density polyethylene (HDPE) or any polyethylene thermoplastic made from petroleum. HDPE is known for its large strength to density ratio and is commonly used in the production sumps and other plastic products.

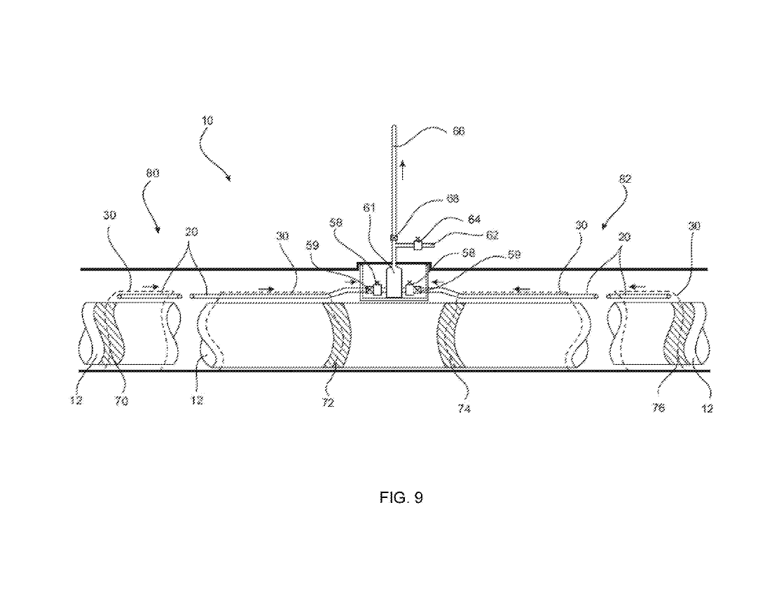

FIG. 9 shows a side view of a pipeline leak detection system 10. The flexible cover 30 (shown in dotted line format) between ends 70, 72 defines a first section 80 and the flexible cover 30 (shown in dotted line format) between ends 74, 76 defines a second section 82. Ends 70, 72, 74, 76 of the flexible covers 30 are attached to the pipeline 12 by adhesive tape. Attaching ends 70, 72, 74, 76 of the flexible covers 30 to the pipeline effectively seals each flexible cover 30 to the pipeline 12. A porous hose 20 is placed adjacent each section 80, 82 of the pipeline 12 and covered by a respective flexible cover 30. Each porous hose 20 is fluidly connected to the gas chamber 61. An isolation valve 58 and a non return valve 59 are disposed between each porous hose 20 and the gas chamber 61. A pipe 62 is fluidly connected to the gas chamber 61 and to a gas detector (not shown). An isolation valve 64 is disposed between pipe 62 and the gas chamber 61. A vent pipe 66 is fluidly connected to the gas chamber 61 to vent gas from the gas chamber 61. An isolation valve 68 is disposed between the gas chamber 61 and the vent pipe 66 to regulate the venting of gas from the gas chamber 61.

While the present invention has mainly been described in relation to the collection of gas, a skilled person would equally appreciate that the invention could be utilised for the collection of any fluid. The fluid collection members in the form of porous hoses 20, 22, 24, 26, 50 are attached to the pipeline 12. Alternatively, the porous hoses may be perforated pipes having holes sized to allow the transmission of liquid or gas. An example of a porous hose is the 3331HM dripping hose made by Holeman Industries. It should be appreciated that any number of different types of pipes or porous hoses may be used to collect the gas or liquid. By way of a further example, the porous hose may be manufactured from an extruded porous rubber and/or plastic material. Any combination of porous hoses or slotted or perforated pipes may be positioned under the flexible cover 30 and located in any number and any configuration around the pipeline 12.

The porous hoses 20, 22, 24, 26, 50 are attached to the pipeline 12 with adhesive or adhesive tape to maintain their relative position when the flexible cover 30 is wrapped around the pipeline 12.

The gas leaks from pipelines 12 are collected by the impervious flexible plastic blanket or flexible cover 30. Generally the flexible cover 30 covers at least part of the pipeline 12 including at least one fluid collection member or pipe 20, 22, 24, 26, 50. For example the flexible cover 30 may be a porous lining of spun geo-fabric which allows the gas from a leak in a pipeline 12 to permeate to the top or base of the flexible cover 30 to be contained. The flexible cover may be made of extruded plastic of a type that does not deteriorate with U.V light or when in contact with the type of materials being transported via the transmission pipeline. Likewise the flexible cover must be of sufficient strength so that it does not tear easily when it comes into contact with the soil or backfill which is placed around the outside of the flexible caver and pipeline 12. The colour of the flexible cover 30 is such that it acts a visual “no dig” indicator when the transmission pipeline is being excavated for maintenance or repairs.

As shown in FIG. 9 the flexible cover 30 is of sufficient width to fully cover the transmission pipe 12 and tuck in under the base of the transmission pipe, so as to provide a full conduit for any gas leaks. The flexible cover when wrapped around the pipeline is of a width which allows one side of the flexible cover to overlap an opposed side, such that the two sides attach to each other, and the overlap is generally positioned underneath the pipeline 12.

The ends of the flexible cover 30 are attached to the pipeline by adhesive or any other fixing device which allows the flexible cover to be positioned in place around the pipeline 12. For example the flexible cover 30 may be held in place by bands to strap the flexible cover to the pipeline, the bands being tightened around the flexible cover and pipeline and having end portions crimped together.

The present invention has been designed to allow for different length sections or zones of containment. In this arrangement the flexible cover 30 can be intermittently or regularly attached to the pipeline 12 at pre-determined lengths as illustrated in FIG. 9. The flexible cover 30 is of a determined length for the monitoring of gas leaks. The ends of the flexible cover 30 can be sealed, by taping the ends of the flexible cover to the transmission pipeline 12. In this arrangement a central gas collection chamber 61 is located on top of the transmission pipeline 12 into which the monitoring leak pipes 20 terminate. The monitoring leak pipes 20 are sealed with a plug (not shown) at the ends of the flexible cover 30. An isolation valve 58 either operated manually or via a solenoid is located at the gas chamber end 61 to allow for individual testing of each leak detection monitoring pipe 20.

The different length sections or zones are required when for example a pipeline 12 is located close to or near residential dwellings. A number of factors determine the lengths of the zones such as, the type of material which is being transmitted in the pipeline 12, the pressure and flow rate of the material in the pipeline, and any environmental issues which may be related to or dictated by the surrounding area of the pipeline.

The present invention provides a fluid detector (not shown) in fluid communication with a fluid collection member 20. The fluid detector may consist of a gas detection monitoring machine which can be permanently or removably connected to the gas chamber 61 to detect the presence of gas. When permanently connected to the gas chamber 61 the detector can provide an alarm signal or warning which can be transmitted to a pipeline monitoring control centre via analogue or digital signal. The centre may be remotely located from the pipeline and could be located in a central location in which a number of pipelines can be remotely monitored for leaks. The signals provided might include but is not limited to a location or designation of the fluid collection member from which the fluid was detected; or an amount of fluid detected.

Power for the monitoring machine, the alarm and any signal transmitter may be provided by a rechargeable battery or a renewable energy source such as solar or wind energy. The power supply may also include circuitry to charge the batteries and battery monitoring circuits to monitor the charge levels. These levels may also be transmitted to a remote location away from the pipeline 12 to a location such as the pipeline monitoring control centre.

With the above embodiment when a leak is detected either a trained maintenance operator or team of trained operators will be sent to the section of transmission pipe 12 showing a gas leak.

In the embodiment where the gas detection monitoring machine is removably connected to the gas chamber 61, the gas monitoring machine and any resulting gas leak can be detected manually from an inspection vehicle with a trained operator, using a state of the art hand held laser gas detector without the need to get out of the vehicle. This laser detector can show the concentration and size of the gas cloud around a vent pipe 66, thus showing the operator the extent of the gas leak, and enabling him to then access the site safely of a closer inspection and testing for the leak.

In a large pipeline 12 individual gas monitoring pipes 20, may be individually tested by isolating the other monitoring pipes, using the isolating valves 59 attached to the gas chamber 61. A vacuum pump (not shown) may be attached to a portable gas detection machine and used to evacuate the monitoring pipe 20 and collect any residual leaked gas from around the monitoring pipe 20. This will allow an indication of the direction of the gas leak along the transmission pipe 12.

A closer inspection may then be carried out to determine the exact location and size of the gas leak using standard state of the art detection machines, such as a hand held gas detection probe or a directional microphone probe to locate the position of the gas leak.

In accordance with the present invention the fluid detector in fluid communication with the fluid collection pipes 20 is a gas detector device which detects the presence of various gases within an area or pipeline 12. This type of equipment is used to detect a gas leak and interface with the central pipeline monitoring station so as a leak can be easily and quickly detected. Gas detectors can be classified according to the operation mechanism (semiconductors, oxidation, catalytic, infrared, etc.).

Typically the pipeline 12 is a buried pipeline. The pipeline leak detection system may be retrofitted to an existing buried pipeline. Alternatively, the pipeline leak detection system may be installed at the same time as the pipeline is being installed. If the pipeline leak detection system is to be retrofitted to an existing buried pipeline, the existing buried pipeline is typically excavated using suction excavation (e.g. the earth/material around the pipeline is removed using suction). The present invention is not limited to any particular diameter pipeline or any particular length of pipeline.

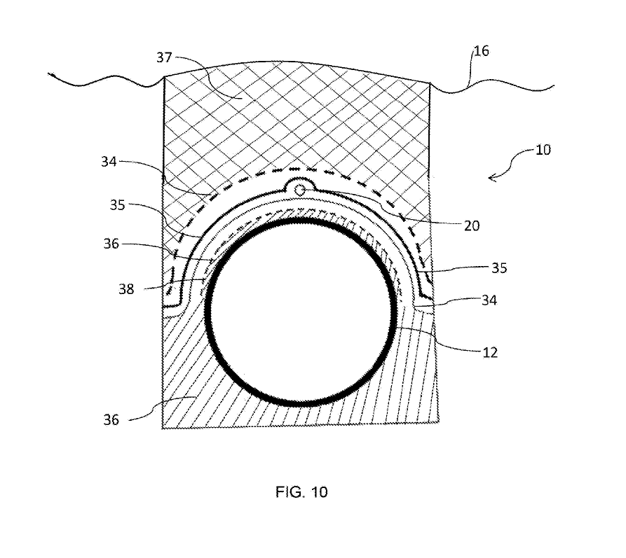

In order to maintain cathodic protection of the pipeline when using suction excavation to retrofit the pipeline leak detection system to an existing pipeline a modified installation is carried out as illustrated in FIG. 10. Cathodic protection, also referred to as a sacrificial cathode, is a technique used to control the corrosion of a metal surface by making it the cathode of an electrochemical cell. A simple method of protection connects protected metal to a more easily corroded “sacrificial metal” to act as the anode. The sacrificial metal then corrodes instead of the protected metal. For structures such as long pipelines, where passive galvanic cathodic protection is not adequate, an external DC electrical power source is used to provide sufficient current.

To assist in maintaining cathodic protection of the pipeline a layer of bedding sand 36 is firstly placed under and around the pipeline 12. A plastic and/or stainless steel earthing mesh 38 for enhanced cathodic protection is placed over the bedding sand 36 and on top of the pipeline 12. The plastic mesh 38 is used to hold and maintain the bedding sand 36 in contact with the pipeline 12 such that the thin layer of bedding sand 36 is used to maintain the cathodic protection for the pipeline 12. The bedding sand 36 is kept slightly moistened in order to provide a good connection to the pipeline 12. A first geo-fabric layer 34 is then placed over the plastic mesh 38. The bedding sand 36 is kept moistened by the ground moisture in the trench which is collected under the impervious layer or membrane 35 and thus maintaining the cathodic conductivity of the pipeline 12.

A porous hose 20 is then placed on top of the geo-fabric 34 and is located on a top portion of the pipeline 12. Covering the porous hose 20 and the pipeline 12 is the membrane 35. The membrane 35 may be an inert high density polyethylene membrane such as Layfield's Enviro Liner 6000HD. On top of the membrane 35 a further geo-fabric layer 34 to provide UV protection. Finally a layer of back fill 37 such as crushed gravel or soil 37 is laid on top to protect the flexible liner/cover and membrane from UV sunlight deterioration and to allow vehicle traffic over the flexible cover for work and maintenance of the wellhead.

Alternatively the flexible cover may comprise any or more of the following: a) a poly-fabric; b) a polyethylene based poly-fabric; c) a plastic or PVC sheet/foil material; d) an impervious sprayed polyurethane sealant onto a geo-fabric or woven/knitted mat sheet; e) an impervious liner with a porous lining on the bottom; or f) an impervious liner with a porous lining on the bottom and on the top. For example, Canvacon E 5000, a polyethylene based polyfabric sold by Gale Pacific Limited or the inert high density polyethylene membrane such as Layfield's Enviro Liner 6000HD material as described above. A further example of a sprayable polyethylene based poly-fabric is Eraspray ESM900a sprayable polyethylene based modified polyurea product sold by ERA Polymers Pty Ltd.

A skilled addressee will understand that any suitable flexible cover may be used such as plastic sheet/foil material, PVC sheeting/foil, impervious fabrics, sprayable polyurethane and/or the like.

By way of a further example the flexible cover may comprise a first layer and a second layer separated by an impervious membrane. Each layer (first and second) consists of top and bottom geo-fabric layers separated by a mesh layer. The flexible cover being a multi-layer construction.

### Advantages

The present invention has been designed to capture leaked fluids and has been found to be particularly useful for capturing leaked gas from pipelines thereby significantly mitigating both environmental and personal safety risks and/or provide the consumer with an effective risk management plan and commercial means to identify potential loss or leaking gases from pipelines which may otherwise be leaked into the surrounding environment.

Another important advantage that the present system is the benefit to the CSG/oil companies:
Retrofitting of the system to existing pipelines.
Minimal Maintenance—the system is simple, practical and effective with minimal maintenance requirements. The flexible materials used in system have a long life span (at least 30+ years) and any leaks detected after installation are easily contained.
Protection of licensed to extract gas and oil from adverse government action or intervention
Carbon footprint reduction resulting in minimal if any carbon tax or similar penalties.
Employee safety risk reduction—there will be less need for gas company employees to attend pipeline installations to check for leaking gases. Employees will be traveling less on public roads to attend pipeline sites and therefore maintenance and safety costs will be drastically reduced.
Initial outlay cost effective—One off cost of installation of the system is cost effective and there exists a real opportunity to increase company profits through early and quick detection of leaking gases.

### Variations

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the scope of the above described invention.

In the present specification and claims (if any), the word “comprising” and its derivatives including “comprises” and “comprise” include each of the stated integers but does not exclude the inclusion of one or more further integers unless the context of use indicates otherwise.

In the specification the term “fluid” shall be understood to include a substance, as a liquid or gas or a combination of both, that is capable of flowing and that changes its shape at a steady rate when acted upon by a force tending to change its shape. The term “fluid” may also extend to include plasmas and, to some extent, plastic solids.

1-48. (canceled)

49. A pipeline leak detection system comprising:
at least one fluid collection member adapted to be placed externally of and adjacent to a pipeline and adapted to receive fluid leaking from the pipeline;
a flexible cover covering at least part of the pipeline and the at least one fluid collection member; and
a fluid detector in fluid communication with the at least one fluid collection member.

50. A system as claimed in claim 49, wherein the at least one fluid collection member comprises at least one porous conduit.

51. A system as claimed in claim 50, wherein each porous conduit is a perforated pipe having holes sized to allow the transmission of the fluid into the pipe; and/or each porous conduit is a porous hose, each porous hose is made of extruded porous rubber, plastic or metal based material.

52. A system as claimed in claim 51, wherein the at least one porous conduit comprises a plurality of porous conduits, including a combination of one or more perforated pipes and one or more porous hoses.

53. A system as claimed in claim 50, wherein the one or more porous conduits comprises at least one porous conduit located towards the top of the pipeline; and/or at least one porous conduit located towards the bottom of the pipeline.

54. A system as claimed in claim 49, wherein the flexible cover comprises any combination of one or more of impervious material or the like, a polyfabric material and/or a polyethylene based polyfabric material.

55. A system as claimed in claim 49, wherein the flexible cover comprises an impervious material and: further comprises a porous lining, the porous lining is positioned adjacent the pipeline and the at least one fluid collection member such that any fluid leaking from the pipeline can flow through the porous lining to the at least one fluid collection member; or further comprises a porous lining, the porous lining is positioned adjacent the pipeline and the at least one fluid collection member such that any fluid leaking from the pipeline can flow through the porous lining to the at least one fluid collection member and the porous lining comprises a spun fabric such as a spun geo-fabric.

56. A system as claimed in claim 49, wherein the flexible cover comprises an impervious material and: the flexible cover is wide enough to enclose the pipeline such that any backfill puts pressure on the flexible cover to keep it in place relative to the pipeline; and/or wherein the flexible cover is placed around the pipeline and one side of the flexible cover overlaps an opposed side of the flexible cover such that the two sides attach to each other, and the overlap is positioned underneath the pipeline.

57. A system as claimed in claim 49, wherein the flexible cover can be intermittently attached to the pipeline at portions which are spaced apart locations along the pipeline using bands to strap the flexible cover to the pipeline, the bands being tightened around the flexible cover and pipeline and having end portions crimped together, and wherein the bands attaching the flexible cover to the pipeline define a section of pipeline, the band is tightened such that any fluid collection member is clamped under the band such that any fluid collected by the fluid collection member in one section does not flow into another section.

58. A system as claimed in claim 49, further comprising a vacuum pump in fluid communication with the fluid detector to bring leaked fluid towards the fluid detector such that the fluid can be detected.

59. A system as claimed in claim 49, further comprising a transmitter in operational communication with the fluid detector, such that when a leaked fluid is detected, a signal is transmitted to a monitoring station.

60. A system as claimed in claim 59, wherein the signal would include at least one of the following:
a location or designation of the fluid detector;
a location or designation of the fluid collection member from which the fluid was detected; or
an amount of fluid detected.

61. A system as claimed in any claim 49, wherein the fluid detector is a portable fluid detector.

62. A system as claimed in claim 49, further comprising a vent pipe in fluid communication with the at least one fluid collection member; and wherein the vent pipe extends sufficiently above the pipeline and ground level to help vent gas leaks, such that any leaked gas can be dispersed and prevents pooling of gas at ground level.

63. A system as claimed in claim 62, wherein the gas detector used in conjunction with the vent pipe is a handheld gas detector, such as a handheld laser gas detector which can be used to remotely determine if gas is venting from the vent pipe.

64. A system as claimed in claim 49, further comprising an isolation valve disposed between each of the at least one fluid collection members and the fluid detector and wherein the isolation valves are automatically actuated when a leak is detected to determine which of the fluid collection members is receiving fluid.

65. A system as claimed in claim 49, further comprising a non-return valve disposed between each of the at least fluid collection members and the fluid detector, such that fluid from one fluid collection member cannot flow into another fluid collection member.

66. A system as claimed in claim 49, further comprising a cathodic protection structure including a sacrificial metal or charged ion generator connected to the pipeline for protecting the pipeline from corrosion.

67. A system as claimed in claim 49, wherein the cathodic protection structure comprises:
a layer of bedding sand located adjacent to and external of the pipeline; and
a plastic and/or stainless steel earthing mesh located between the bedding sand and the flexible cover to hold and maintain the bedding sand in contact with the pipeline such that the layer of bedding sand maintains cathodic protection of the pipeline; and wherein the layer of bedding sand is kept moistened in situ by ground moisture captured under the flexible cover.

68. A method of installing a pipeline leak detection system, comprising the steps of:
providing at least one fluid collection member externally of and adjacent to a pipeline such that the at least one fluid collection member can receive fluid leaking from the pipeline;
fluidly connecting the at least one fluid collection member to a fluid detector; and
covering at least part of the pipeline and the at least one fluid collection member with a flexible cover.

69. A method as claimed in claim 68, wherein the method includes installing the leak detection system to a new pipeline; or the method includes retrofitting the leak detection system to an existing pipeline and includes the step of excavating the pipeline.

70. A pipeline leak detection system comprising:
a pipeline for transmitting fluid;
at least one fluid collection member located externally of and adjacent to the pipeline and adapted to receive fluid leaking from the pipeline;
a flexible cover covering at least part of the pipeline and the at least one fluid collection member; and
a fluid detector in fluid communication with the at least one fluid collection member.
